(19) United States
(12) Patent Application Publication
(10) Pub. No.: US 2015/0364233 A1
(43) Pub. Date: Dec. 17, 2015

(54) WATERPROOFING METHOD OF WIRE SPLICED PORTION AND WIRE GROUP ALIGNMENT APPARATUS

(71) Applicant: SUMITOMO WIRING SYSTEMS, LTD., Mie (JP)

(72) Inventors: Tomohiko ASAMI, Mie (JP); Takashi KATOU, Mie (JP); Yasuhiro YOSHIDA, Mie (JP)

(73) Assignee: SUMITOMO WIRING SYSTEMS, LTD., Mie (JP)

(21) Appl. No.: 14/764,361

(22) PCT Filed: Aug. 9, 2013
(86) PCT No.: PCT/JP2013/071610

§ 371 Date: Jul. 29, 2015

(30) Foreign Application Priority Data
Feb. 15, 2013 (JP) 2013-027514

(51) Int. Cl. H01B 17/50; H01R 43/00; H01B 19/02; B60R 16/02; H01B 13/008; H01B 13/06

(52) U.S. Cl. CPC H01B 17/50; H01B 13/008; H01B 13/06; H01B 19/02; B60R 16/0215; H01R 43/005

(57) ABSTRACT

An object is to enable a fluid synthetic resin to easily spread into the gaps between a plurality of insulated wires when a waterproof portion covering a spliced portion of a wire group is obtained by curing the fluid synthetic resin, thereby ensuring a sufficient waterproofing performance. A pair of first clamping portions sandwich a first covering portion of the spliced portion of the wire group between a parallel pair of first supporting surfaces. A swing mechanism reciprocally displaces one of the pair of first clamping portions sandwiching the first covering portion relative to the other and parallel to the first supporting surfaces.

### TECHNICAL FIELD

The present invention relates to a method for waterproofing a spliced portion of a wire group, and a wire group alignment apparatus suitable for use in the method.

### BACKGROUND ART

Wire harnesses installed in vehicles typified by automobiles may occasionally include spliced portions. A spliced portion is a portion where a plurality of conductors exposed from an insulating covering are joined to one another. The spliced portion is formed at an intermediate portion or end portion of a wire group including a plurality of insulated wires. In the following description, insulated wires are simply referred to as wires.

For example, the spliced portion is formed by welding a plurality of conductors together. Alternatively, the spliced portion may be formed by crimping a plurality of conductors with a crimping tool.

As disclosed in Patent Documents 1 and 2, the spliced portion of a wire group is waterproofed by being covered with a synthetic resin. Each of the waterproof portions disclosed in Patent Documents 1 and 2 is a portion where a fluid ultraviolet curable resin has been cured. Note that an ultraviolet curable resin is an example of photo-curable resins.

The waterproof portion made of a synthetic resin covers a region of the wire group that extends from a spliced portion to an end portion of an insulating covering that faces the spliced portion. Such a region is hereinafter referred to as a “waterproof region.”

### CITATION LIST

### Patent Documents

Patent Document 1: JP 2009-136039A
Patent Document 2: JP 2012-080633A

### SUMMARY OF INVENTION

### Technical Problem

The waterproof portion of the wire harness fills the gaps between the plurality of wires at the portion of the insulating covering in the waterproof region. This prevents a liquid from entering the spliced portion from the gaps between the plurality of wires.

However, when a large number of wires are bundled, it is difficult for the fluid synthetic resin to sufficiently spread into the gaps between the plurality of wires. Then, it is not possible to achieve a sufficient waterproofing performance.

Moreover, when the material of the waterproof portion contains a photo-curable resin, irradiation light will not reach the photo-curable resin that fills the internal gaps of the bundled wires. Then, the photo-curable resin flows out before being cured, and it is therefore not possible to achieve a sufficient waterproofing performance.

It is an object of the present invention to enable a fluid synthetic resin to easily spread into the gaps between a plurality of insulated wires when the waterproof portion covering the spliced portion of the wire group is obtained by curing the fluid synthetic resin, thereby ensuring a sufficient waterproofing performance.

### Solution to Problem

A waterproofing method of a wire spliced portion according to a first aspect of the present invention includes a first clamping step, a swinging step, a parallelism maintaining step, and a waterproof portion forming step described below.

(1) The first clamping step is a step of sandwiching, between a parallel pair of first supporting surfaces of a mutually opposed pair of first clamping portions, a first covering portion of a wire group that is located at a position spaced from an end portion of an insulating covering that faces a spliced portion. The wire group includes a plurality of insulated wires and has the spliced portion where conductors of the insulated wires are joined.

(2) The swinging step is a step of reciprocally displacing one of the pair of first clamping portions sandwiching the first covering portion relative to the other and parallel to the first supporting surfaces.

(3) The parallelism maintaining step is a step of maintaining at least the end portion of the insulating covering of the wire group in a parallel state at the end of the swinging step.

(4) The waterproof portion forming step is a step of covering, with a fluid waterproofing material, a waterproof region of the wire group whose state is maintained by the parallelism maintaining step, and further curing the waterproofing material. The waterproof region is a region of the wire group that extends from the spliced portion to the end portion of the insulating covering.

A waterproofing method of a wire spliced portion according to a second aspect of the present invention is one aspect of the waterproofing method of a wire spliced portion according to the first aspect. In the waterproofing method of a wire spliced portion according to the second aspect, the parallelism maintaining step includes a second clamping step, a clamp-releasing step, and a moving step described below.

(3-1) The second clamping step is a step of sandwiching, between a pair of second supporting surfaces, parallel to the first supporting surfaces, of a mutually opposed pair of second clamping portions, a second covering portion of the wire group clamped by the pair of first clamping portions through the swinging step. The second covering portion is a portion of the wire group that is located between the first covering portion and the waterproof region.

(3-2) The clamp-releasing step is a step of releasing the clamping by the first clamping portions after the second clamping step.

(3-3) The moving step is a step of moving the wire group to a position for the waterproof portion forming step by moving the pair of second clamping portions clamping the wire group after the clamp-releasing step.

A waterproofing method of a wire spliced portion according to a third aspect of the present invention is one aspect of the waterproofing method of a wire spliced portion according to the first or second aspect. In the waterproofing method of a wire spliced portion according to the third aspect, the waterproof portion forming step includes a sheet placement step, a waterproofing material supply step, a sheet enveloping step, and an exposure step described below.

(4-1) The sheet placement step is a step of maintaining the waterproof region of the wire group whose state is maintained by the parallelism maintaining step in a state in which the waterproof region is laid on the transparent sheet member.

(4-2) The waterproofing material supply step is a step of supplying the fluid waterproofing material containing a photo-curable resin onto the sheet member.

(4-3) The sheet enveloping step is a step of filling a gap between the waterproof region of the wire group and the sheet member with the fluid waterproofing material by enveloping the waterproof region of the wire group by the sheet member to which the waterproofing material has been supplied.

(4-4) The exposure step is a step of applying light, from outside of the sheet member, to the waterproofing material covering the waterproof region of the wire group.

A waterproofing method of a wire spliced portion according to a fourth aspect of the present invention is one aspect of the waterproofing method of a wire spliced portion according to any one of the first to third aspects. In the waterproofing method of a wire spliced portion according to the fourth aspect, the first clamping step, the swinging step, and the parallelism maintaining step are performed in parallel at positions located on opposite sides of the spliced portion formed at an intermediate portion of the wire group.

Further, the present invention may be regarded as an invention of a wire group alignment apparatus suitable for use in the first clamping step, the swinging step, and the parallelism maintaining step in the above-described aspects. A wire group alignment apparatus according to a fifth aspect of the present invention is an apparatus that aligns a portion of an insulating covering of the wire group into a state in which the plurality of the insulated wires are arranged in a line. Also, the wire group alignment apparatus includes components described below.

(1) A first component is a pair of first clamping portions that have a parallel pair of first supporting surfaces. The pair of first clamping portions sandwich, between the pair of first supporting surfaces, a first covering portion of the wire group that is located at a position spaced from an end portion of the insulating covering that faces the spliced portion.

(2) A second component is a swing mechanism that reciprocally displaces one of the pair of first clamping portions sandwiching the first covering portion relative to the other and parallel to the first supporting surfaces.

A wire group alignment apparatus according to a sixth aspect of the present invention is one aspect of the wire group alignment apparatus according to the fifth aspect. The wire group alignment apparatus according to the sixth aspect further includes components described below.

(3) A third component is a pair of second clamping portions that have a pair of second supporting surfaces parallel to the first supporting surfaces. The pair of second clamping portions sandwich, between the pair of second supporting surfaces, a second covering portion of the wire group clamped by the pair of first clamping portions. The second covering portion is a portion that is located between the first covering portion and the end portion of the insulating covering of the wire group.

(4) A fourth component is a movement mechanism that moves the pair of second clamping portions clamping the wire group after the clamping by the first clamping portion is released.

### Advantageous Effects of Invention

According to the above-described aspects, the first covering portion (the portion of the insulating covering), which is located close to the waterproof region of the wire group, is sandwiched between the pair of first clamping portions. Furthermore, the pair of first clamping portions are reciprocally displaced relative to each other and parallel to the supporting surfaces, while sandwiching the first covering portion.

It is possible that, at the initial stage of being sandwiched between the pair of first clamping portions, the first covering portion is in a state in which the plurality of insulated wires are stacked. However, when the pair of first clamping portions are reciprocally displaced relative to each other, the insulated wires collapse from the stacked state. As a result, the first covering portion is in a state in which all the insulated wires are arranged in parallel along the first supporting surfaces (the parallel state).

In the parallel state in which all the insulated wires are arranged in parallel without being stacked, a dead zone into which the fluid synthetic resin is difficult to flow cannot be easily created. In other words, the fluid synthetic resin can easily spread into the gaps between all the insulated wires. As a result, a sufficient waterproofing performance can be ensured when the waterproof portion covering the spliced portion of the wire group is obtained by curing the fluid synthetic resin.

In the second and sixth aspects, the wire group is transferred from the pair of first clamping portions clamping the first covering portion to the pair of second clamping portions clamping the second covering portion, which is located closer to the spliced portion than the first covering portion. Further, the wire group is moved to the position for the waterproof portion forming step while being clamped by the pair of second clamping portions.

According to the second and sixth aspects, even when the waterproof portion forming step is performed at a position different from the position for the first clamping step, the portion of the wire group from the second covering portion to the end portion of the insulating covering is maintained in the parallel state at the end of the swinging step.

Thus, according to the second and sixth aspects, the waterproof portion forming step for a wire group and the steps (the first clamping step and the swinging step) of aligning another wire group into the parallel state can be performed in parallel. As a result, a wire harness including the waterproof portion that covers the spliced portion can be manufactured efficiently.

In the third aspect, the waterproof portion covering the spliced portion is a portion formed as a result of the fluid waterproofing material containing a photo-curable resin having been cured by receiving light from the outside of the transparent sheet member enveloping the fluid waterproofing material. When a photo-curable resin is used as the waterproofing material, a dead zone where applied light is difficult to reach tends to be created at a portion where the insulated wires are stacked. Accordingly, the present invention is particularly suitable to be applied to such a subject.

The present invention is also applicable to a waterproofing process of a so-called intermediate splice as in the fourth aspect.

### BRIEF DESCRIPTION OF DRAWINGS

FIG. 1 is a schematic perspective view of a wire group alignment apparatus 10 according to an embodiment of the present invention.

FIG. 2 is a plan view of a wire group.

FIG. 3 is a plan view of the wire group on which a waterproof portion is formed.

FIG. 4 is a diagram illustrating a first clamping step of a waterproofing method according to an embodiment of the present invention.

FIG. 5 is a diagram illustrating a swinging step of the waterproofing method according to an embodiment of the present invention.

FIG. 6 is a diagram illustrating a state at the end of the swinging step.

FIG. 7 is a diagram illustrating a state in the course of a second clamping step of the waterproofing method according to an embodiment of the present invention.

FIG. 8 is a diagram illustrating a state at the end of the second clamping step.

FIG. 9 is a plan view illustrating a positional relationship between clamping portions in the second clamping step.

FIG. 10 is a diagram illustrating a clamp-releasing step of the waterproofing method according to an embodiment of the present invention.

FIG. 11 is a diagram illustrating a moving step of the waterproofing method according to an embodiment of the present invention.

FIG. 12 is a diagram illustrating a first example of a waterproofing material supply step of the waterproofing method according to an embodiment of the present invention.

FIG. 13 is a diagram illustrating a first example of a sheet placement step of the waterproofing method according to an embodiment of the present invention.

FIG. 14 is a diagram illustrating a second example of the sheet placement step and the waterproofing material supply step of the waterproofing method according to an embodiment of the present invention.

FIG. 15 is a diagram illustrating a sheet enveloping step of the waterproofing method according to an embodiment of the present invention.

FIG. 16 is a diagram illustrating a sheet enveloping step of the waterproofing method according to an embodiment of the present invention.

FIG. 17 is a diagram illustrating an exposure step of the waterproofing method according to an embodiment of the present invention.

### DESCRIPTION OF EMBODIMENTS

Hereinafter, an embodiment of the present invention will be described with reference to the accompanying drawings. The following embodiment is merely an exemplary embodiment of the present invention, and is not construed to limit the technical scope of the present invention.

<Wire Group>

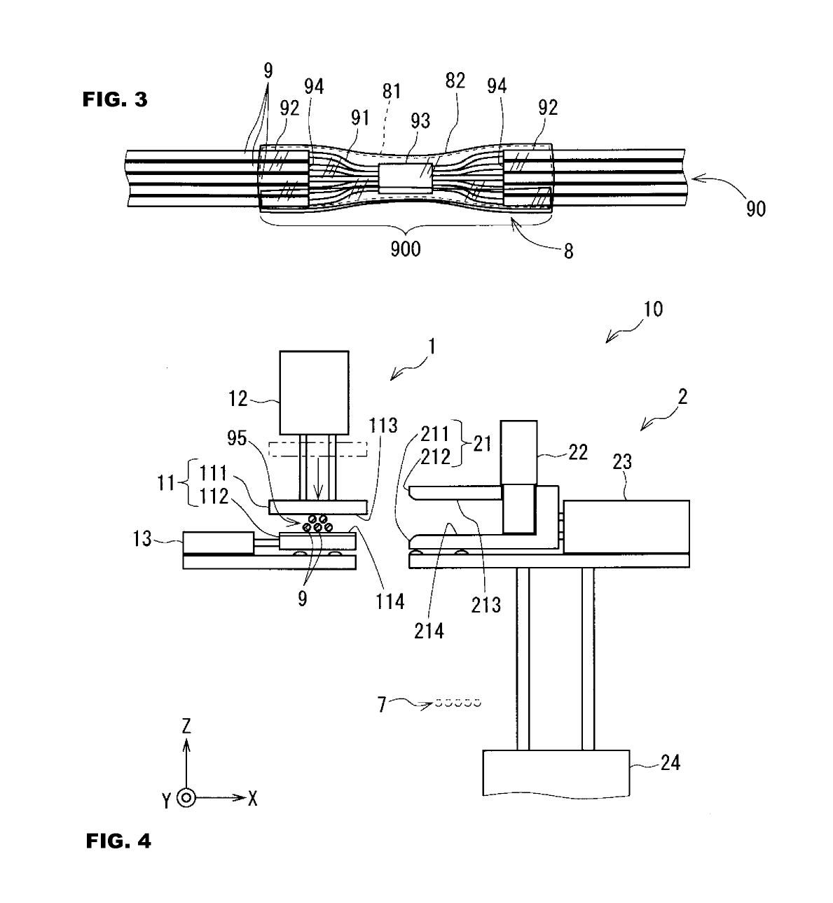

With reference to FIGS. 2 and 3, a description will be first given of a wire group 90 that is subjected to a waterproofing process in a waterproofing method of a wire spliced portion according to an embodiment of the present invention. The wire group 90 constitutes a part of a wire harness installed in a vehicle such as an automobile.

The wire group 90 includes a plurality of wires 9, and further has a spliced portion 93. Each wire 9 is an insulated wire including a linear conductor 91 and an insulating covering 92 that covers the periphery of the conductor 91. The spliced portion 93 is a portion where the conductors 91 of the plurality of wires 9 are joined.

In the spliced portion 93, a plurality of the conductors 91 exposed from the insulating covering 92 are joined to one another. The spliced portion 93 is formed at an intermediate portion or end portion of the wire group 90. In the present embodiment, the spliced portion 93 is formed at an intermediate portion of the wire group 90.

The conductors 91 are joined to one another, for example, by resistance welding, ultrasonic welding, laser welding, or the like. Alternatively, the conductors 91 may be joined to one another by crimping using a crimping tool.

As shown in FIG. 3, a waterproof portion 8 is formed in a predetermined region of the wire group 90 that includes the spliced portion 93. Hereinafter, the region of the wire group 90 in which the waterproof portion 8 is formed is referred to as a “waterproof region 900.”

The waterproof region 900 is a region of the wire group 90 that extends at least from the spliced portion 93 to covering end portions 94. Each covering end portion 94 is an end portion of the insulating covering 92 that faces the spliced portion 93. Accordingly, the waterproof region 900 includes the spliced portion 93 and all portions of the conductors 91 exposed from the insulating covering 92, adjacent to the spliced portion 93.

The waterproof portion 8 includes a waterproofing material 81 and a sheet member 82. The waterproofing material 81 is a synthetic resin material that covers the waterproof region 900 of the wire group 90. The sheet member 82 envelops the waterproofing material 81 in a state in which the sheet member 82 is wrapped around the waterproof region 900 from the outside of the waterproofing material 81.

The sheet member 82 prevents the fluid waterproofing material 81 from flowing out. In addition, the waterproofing material 81 and the sheet member 82, each of which is made of a nonconductive material, constitute an insulating covering of the spliced portion 93.

The waterproofing material 81 is obtained as a result of curing of the fluid synthetic resin supplied to the waterproof region 900. The waterproof region 900 to which the fluid waterproofing material 81 has been supplied is enveloped by the sheet member 82 before the synthetic resin is cured.

As a result of the waterproof region 900 being enveloped by the sheet member 82, the gap between the waterproof region 900 and the sheet member 82 is filled with the fluid waterproofing material 81. Subsequently, the waterproofing material 81 is cured, thereby forming a waterproof portion 8.

In the present embodiment, a photo-curable resin is used as the waterproofing material 81. In this case, the sheet member 82 is a transparent film. Note that “transparent” means being capable of allowing transmission of light of a band required to cure the waterproofing material 81. In addition, “transparent” as used herein encompasses both fully transparent and semi-transparent.

In the following description, a predefined area of the wire group 90 that is spaced from the covering end portion 94 facing the spliced portion 83 is referred to as a “first covering portion 95.” The first covering portion 95 is a portion other than the waterproof region 900. Additionally, a predefined area of the wire group 90 that is located between the first covering portion 95 and the waterproof region 900 is referred to as a “second covering portion 96.” Note that examples of the first covering portion 95 and the second covering portion 96 are shown in FIG. 2.

<Wire Group Alignment Apparatus>

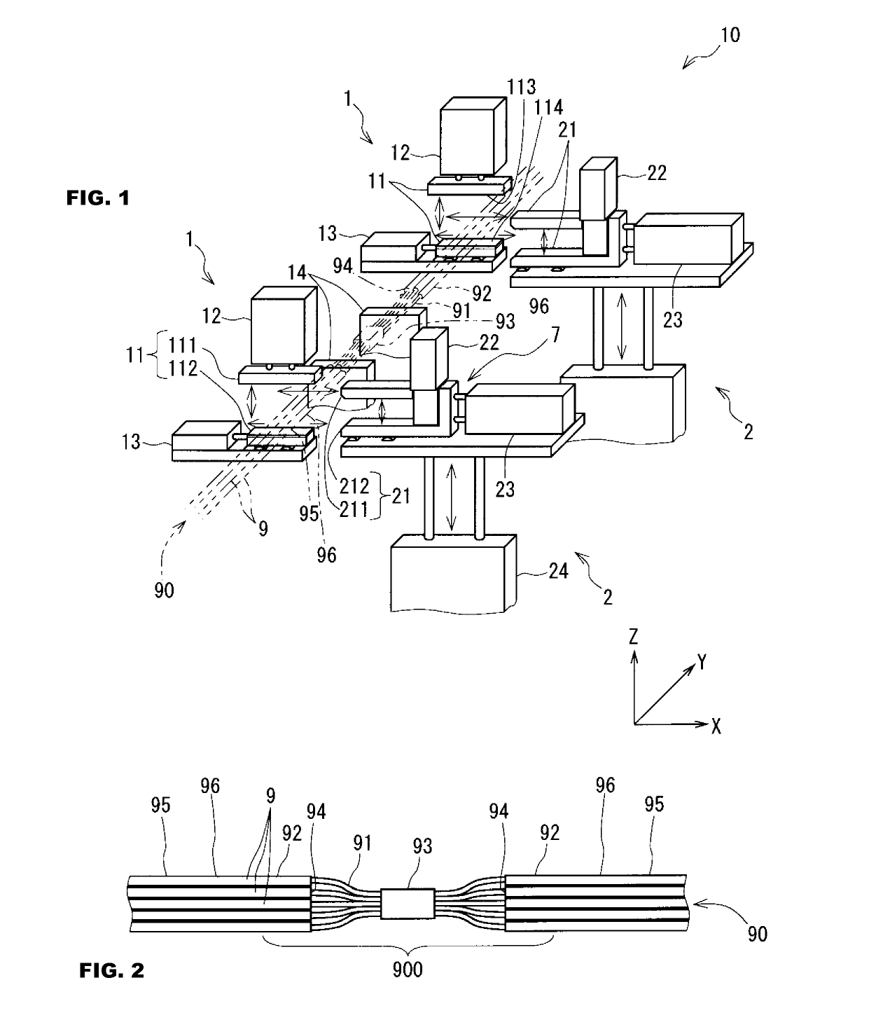

Next is a description of the configuration of a wire group alignment apparatus 10 according to an embodiment of the present invention, with reference to FIGS. 1 and 4. The wire group alignment apparatus 10 is used in a preceding step of a step in which the waterproof portion 8 covering the spliced portion 93 of the wire group 90 is formed.

Note that FIG. 4, which is a diagram illustrating a first clamping step of a waterproofing method according to an embodiment of the present invention, is also a side view of the wire group alignment apparatus 10.

The wire group alignment apparatus 10 is an apparatus that aligns the portion of the insulating covering 92 of the wire group 90 including the spliced portion 93 into a state in which the plurality of wires 9 are arranged in a line. More specifically, the wire group alignment apparatus 10 aligns the portion of the wire group 90 that extends from the first covering portion 95 to the covering end portion 94 into a state in which the plurality of wires 9 are arranged in a line.

As shown in FIG. 1, the wire group alignment apparatus 10 includes two sets of alignment mechanisms 1 and two sets of parallelism maintaining mechanisms 2. Note that the wire group 90 set in the wire group alignment apparatus 10 is depicted by the phantom line (dashed double-dotted line) in FIG. 1.

<Alignment Mechanism>

In addition, the alignment mechanisms 1 each include a pair of first clamping portions 11, a first clamping actuator 12, a swing mechanism 13, and a wire supporting portion 14. Further, the pair of first clamping portions 11 include a first pressing portion 111 and a first receiving portion 112 that are mutually opposed.

The pair of first clamping portions 11 are members having a parallel pair of first supporting surfaces 113 and 114, respectively. In the present embodiment, each of the pair of first supporting surfaces 113 and 114, or in other words, each of the first supporting surface 113 of the first pressing portion 111 and the first supporting surface 114 of the first receiving portion 112 is a flat surface.

The first clamping actuator 12 is a displacement mechanism that changes the interval between the pair of first clamping portions 11, or in other words, the interval between the pair of first supporting surfaces 113 and 114. In the present embodiment, the first clamping actuator 12 moves the first pressing portion 111 toward and away from the first receiving portion 112.

The pair of first clamping portions 11 sandwich the first covering portion 95 of the wire group 90 between the pair of first supporting surfaces 113 and 114 by the operation of the first clamping actuator 12. Further, the pair of first clamping portions 11 release the clamping of the first covering portion 95 of the wire group 90 by the operation of the first clamping actuator 12.

In other words, the pair of first clamping portions 11 sandwich the first covering portion 95 of the wire group 90 by the first clamping actuator 12 moving the first pressing portion 111 toward the first receiving portion 112. The pair of first clamping portions 11 release the clamping of the wire group 90 by the first clamping actuator 12 moving the first pressing portion 111 away from the first receiving portion 112.

The first clamping actuator 12 presses the first pressing portion 111 toward the first receiving portion 112 by an elastic force. In other words, the pair of first clamping portions 11 sandwich the first covering portion 95 by an elastic force. Accordingly, in a state in which the pair of first clamping portions 11 sandwich the first covering portion 95, the interval between the pair of first clamping portions 11 changes in accordance with the change in the thickness of the first covering portion 95.

To exert an elastic force on the first pressing portion 111, the first clamping actuator 12 may be an air cylinder-type actuator. Alternatively, a spring mechanism (not shown) may be incorporated in the first clamping actuator 12.

The wire supporting portion 14 is a portion that supports the wire group 90, together with the first receiving portion 112. The wire supporting portion 14 has the function of supporting the wire group 90, mainly before the wire group 90 is clamped by the pair of first clamping portions 11.

Here, a description will be given of each of the X-axis, Y-axis, and Z-axis directions of the coordinate axes shown in the drawings. The Y-axis direction is a direction of extension (longitudinal direction) of the wire group 90 disposed between the pair of first clamping portions 11. The Z-axis direction is a direction in which the pair of first clamping portions 11 are displaced relative to each other in order to sandwich the wire group 90. In the present embodiment, the Z-axis direction is a direction in which the first pressing portion 111 is displaced. The X-axis direction is a direction orthogonal to the Y-axis direction and the Z-axis direction.

In the present embodiment, the parallel pair of first supporting surfaces 113 and 114 are flat surfaces extending along the X-axis direction and the Y-axis direction. Additionally, the X-axis direction and the Y-axis direction are horizontal directions, and the Z-axis direction is a vertical direction.

The swing mechanism 13 is a mechanism that reciprocally displaces one of the pair of first clamping portions 11 sandwiching the first covering portion 95 of the wire group 90 relative to the other and parallel to the first supporting surfaces 113 and 114. The swing mechanism 13 in the present embodiment reciprocally displaces the first receiving portion 112 in a direction (the X-axis direction) orthogonal to the direction of extension of the wire group 90.

The swing mechanism 13 is formed by an air cylinder-type actuator or the like. For example, the swing mechanism 13 performs the reciprocal displacement with a displacement amount of about several millimeters to several tens of millimeters. The number of reciprocations in that case may be two to four, for example.

The wire group alignment apparatus 10 including the two sets of alignment mechanisms 1 is used for an alignment process of the wire group 90 having the spliced portion 93 formed at its intermediate portion. One of the alignment mechanisms 1 performs the clamping by the pair of first clamping portions 11 and the reciprocal operation of the first receiving portion 112 by the swing mechanism 13 at one of the first covering portions 95 located on opposite sides of the spliced portion 93 of the wire group 90. Likewise, the other alignment mechanism 1 performs the clamping by the pair of first clamping portions 11 and the reciprocal operation of the first receiving portion 112 by the swing mechanism 13 at the other of the first covering portions 95 located on opposite sides of the spliced portion 93 of the wire group 90. The processes by the two sets of alignment mechanisms 1 are performed in parallel at positions located on opposite sides of the spliced portion 93.

<Parallelism Maintaining Mechanism>

Each parallelism maintaining mechanism 2 is a mechanism that maintains a region of the portion of the insulating covering 92 of the wire group 90 that is located toward the end portion 94 with respect to the first covering portion 95 in the state (parallel state) at the end of the process performed by the alignment mechanism 1. Further, the parallelism maintaining mechanism 2 moves the wire group 90 to a position for the subsequent step, while maintaining the region located toward the end portion 94 with respect to the first covering portion 95 in the state at the end of the process performed by the alignment mechanism 1.

As shown in FIGS. 1 and 4, the parallelism maintaining mechanism 2 includes a pair of second clamping portions 21, a second clamping actuator 22, a transverse actuator 23, and an elevation actuator 24. Further, the pair of second clamping portions 21 include a second pressing portion 211 and a second receiving portion 212 that are mutually opposed.

The pair of second clamping portions 21 are members having a parallel pair of second supporting surfaces 213 and 214, respectively. The pair of second supporting surfaces 213 and 214 are surfaces parallel to the pair of first supporting surfaces 113 and 114.

As will be described later, the pair of second clamping portions 21 transfer the wire group 90 to and from the pair of first clamping portions 11. It is only required that the pair of second supporting surfaces 213 and 214 are parallel to the pair of first supporting surfaces 113 and 114 at the time when such transfer is performed.

As with the first clamping actuator 12, the second clamping actuator 22 changes the interval between the pair of second clamping portions 21, or in other words, the interval between the pair of second supporting surfaces 213 and 214. In the present embodiment, the second clamping actuator 22 moves the second pressing portion 211 toward and away from the second receiving portion 212.

The pair of second clamping portions 21 sandwich the second covering portion 96 of the wire group 90 between the pair of second supporting surfaces 213 and 214 by the operation of the second clamping actuator 22. Further, the pair of second clamping portions 21 release the clamping of the second covering portion 96 of the wire group 90 by the operation of the second clamping actuator 22.

It is preferable that, as with the first clamping actuator 12, the second clamping actuator 22 presses the second pressing portion 211 toward the second receiving portion 212 by an elastic force. This prevents the breakage of the wire group 90 due to an excessively strong clamping force of the pair of second clamping portions 21, or the detachment of the wire group 90 due to an excessively weak clamping force of the pair of second clamping portions 21.

The transverse actuator 23 and the elevation actuator 24 are examples of the movement mechanism that moves the pair of second clamping portions 21. The transverse actuator 23 moves the pair of second clamping portions 21 in a direction (the X-axis direction) parallel to the direction of the reciprocal displacement performed by the swing mechanism 13.

On the other hand, the elevation actuator 24 moves the pair of second clamping portions 21 in a direction intersecting the direction of the reciprocal displacement performed by the swing mechanism 13. In the present embodiment, the elevation actuator 24 moves the pair of second clamping portions 21 in a direction (the Z-axis direction) orthogonal to the direction of the reciprocal displacement performed by the swing mechanism 13.

The transverse actuator 23 and the elevation actuator 24 move the pair of second clamping portions 21 between the position of the second covering portion 96 of the wire group 90 clamped by the pair of second clamping portions 21 and the position at which the second covering portion 96 is to be disposed in the subsequent step. Note that the subsequent step is a step of forming the waterproof portion 8 in the waterproof region 900 of the wire group 90.

More specifically, the transverse actuator 23 and the elevation actuator 24 move the pair of second clamping portions 21 to the position of the second covering portion 96 after the pair of first clamping portions 11 have clamped the first covering portion 95 of the wire group 90. For example, the transverse actuator 23 and the elevation actuator 24 move the pair of second clamping portions 21 to the position of the second covering portion 96 when the reciprocal displacement operation by the swing mechanism 13 has ended.

Further, the transverse actuator 23 and the elevation actuator 24 move the pair of second clamping portions 21 after the wire group 90 has been transferred from the pair of first clamping portions 11 to the pair of second clamping portions 21. At that time, the transverse actuator 23 and the elevation actuator 24 move the wire group 90 to a position 7 for a waterproof portion forming step by moving the pair of second clamping portions 21 clamping the wire group 90.

<Waterproofing Method of Wire Spliced Portion>

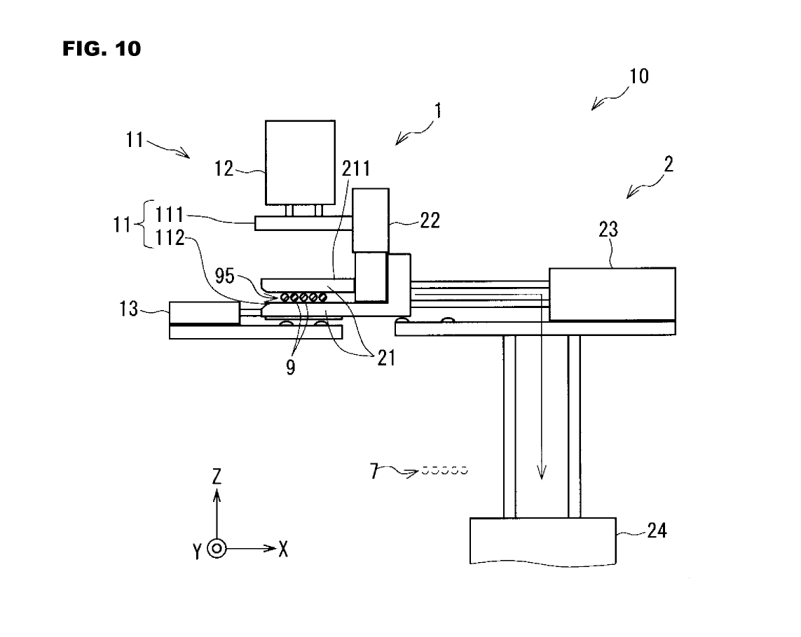

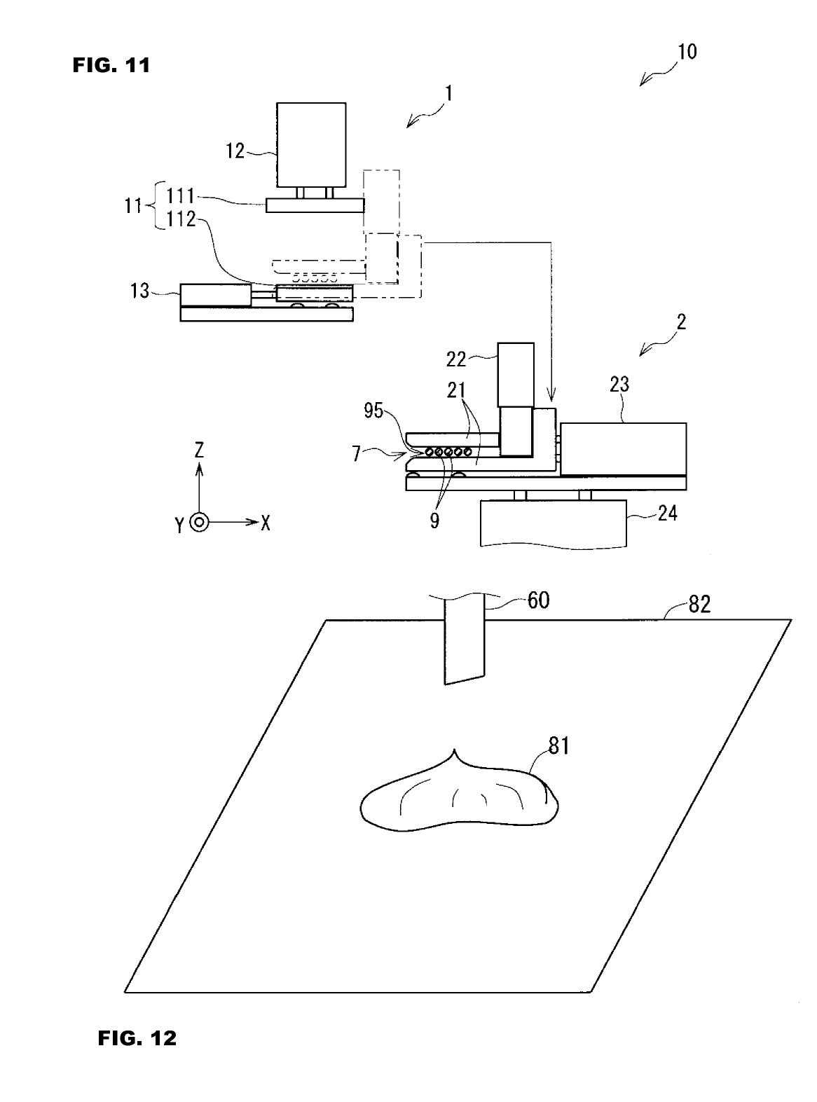

Next is a description of a waterproofing method of a wire spliced portion according to an embodiment of the present invention, with reference to FIGS. 4 to 17. In the waterproofing method, the steps described below are performed.

<First Clamping Step>

As shown in FIG. 4, the first clamping step is a step of sandwiching the first covering portion 95 of the wire group 90 between the parallel pair of first supporting surfaces 113 and 114 of the pair of first clamping portions 11. The present step is performed by the operation of the first clamping actuator 12. In addition, the present step is performed in a state in which the wire group 90 is placed on the first receiving portion 112 and the wire supporting portion 14.

As shown in FIG. 4, at the initial stage of being sandwiched between the pair of first clamping portions 11, the first covering portion 95 may be in a state in which the plurality of wires 9 are stacked.

<Swinging Step>

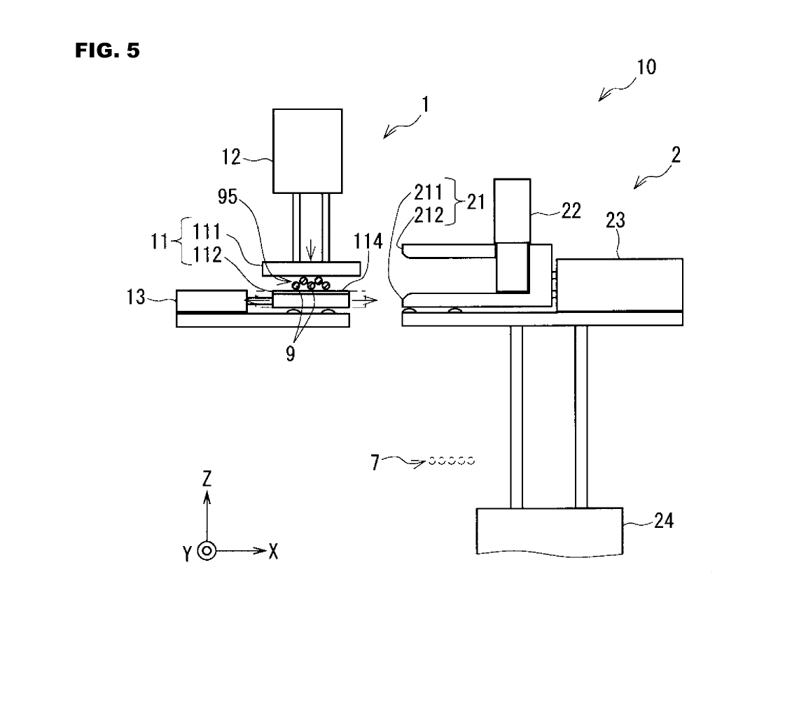

As shown in FIG. 5, the swinging step is a step of reciprocally displacing one of the pair of first clamping portions 11 sandwiching the first covering portion 95 relative to the other and parallel to the first supporting surfaces 113 and 114. The present step is performed by the operation of the swing mechanism 13.

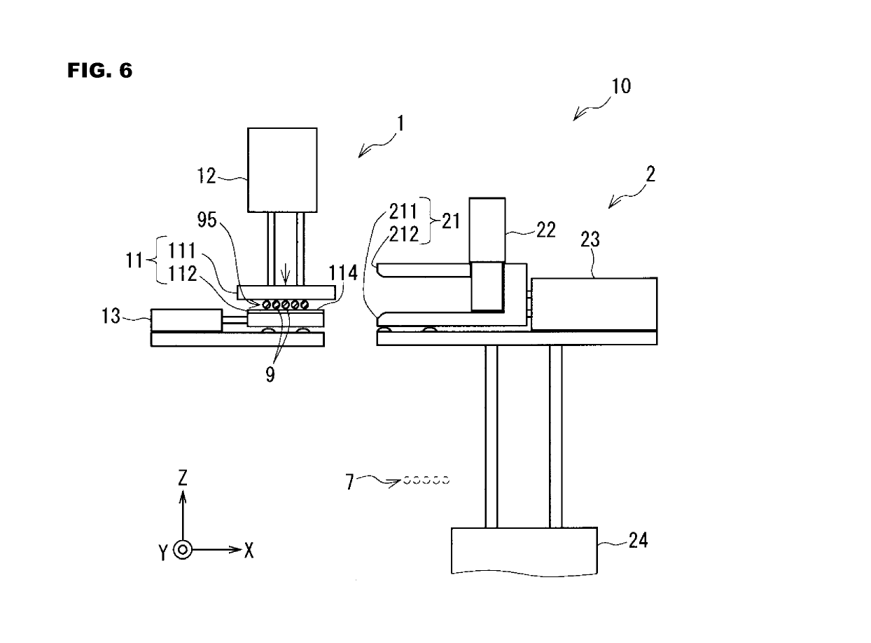

In the swinging step, the pair of first clamping portions 11 are reciprocally displaced relative to each other and parallel to the first supporting surfaces 113 and 114, while sandwiching the first covering portion 95. When the pair of first clamping portions 11 are reciprocally displaced relative to each other, the wires 9 are collapsed from the stacked state. As a result, the first covering portion 95 is in a state in which all the wires 9 are arranged in parallel along the first supporting surfaces 113 and 114 (the parallel state) as shown in FIG. 6.

In order for the swinging step to function effectively, it is desirable that one of the pair of first supporting surfaces 113 and 114 is formed of a material having a higher coefficient of friction to the wire 9 than that of the other. For example, the first supporting surface 113 of the first pressing portion 111 may be a smooth metal surface, and the first supporting surface 114 of the first receiving portion 112 may be a surface of a member made of a rubber material such as an elastomer.

<Parallelism Maintaining Step>

Next, a step of maintaining at least the covering end portion 94 of the wire group 90 in the parallel state at the end of the swinging step (parallelism maintaining step) is performed.

When the step of forming the waterproof portion 8 in the waterproof region 900 of the wire group 90 (waterproof portion forming step) is performed at the same position as the swinging step, the pair of first clamping portions 11 need only to continue to clamp the first covering portion 95 of the wire group 90. In this case, a step in which the pair of first clamping portions 11 continue to clamp the first covering portion 95 of the wire group 90 is the parallelism maintaining step.

On the other hand, in the present embodiment, the wire group 90 that has been subjected to the swinging step is promptly moved to the location for the subsequent step in order to make the wire harness manufacturing process more effective through a flow process. Doing so enables the first clamping step and the swinging step to be performed in parallel with the waterproof portion forming step. For this purpose, a second clamping step, a clamp-releasing step, and a moving step described below are performed in the parallelism maintaining step of the present embodiment.

<Second Clamping Step (Parallelism Maintaining Step)>

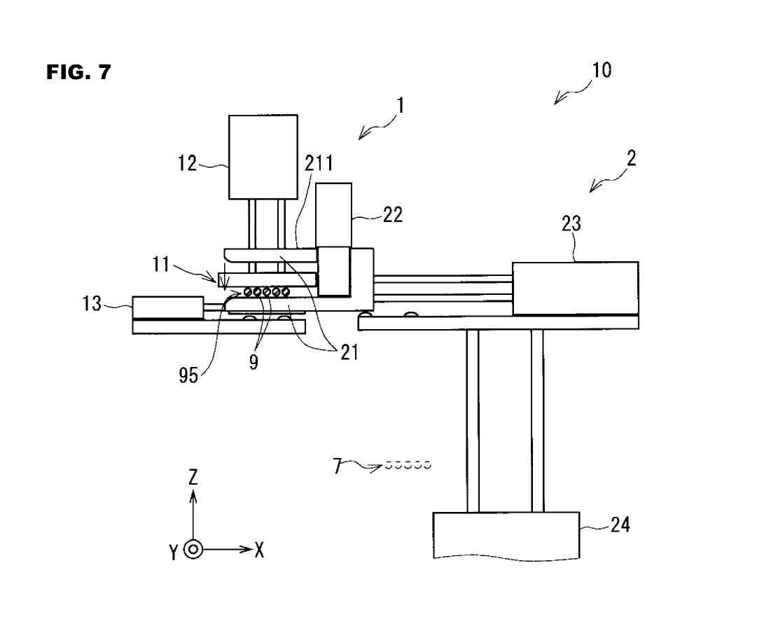

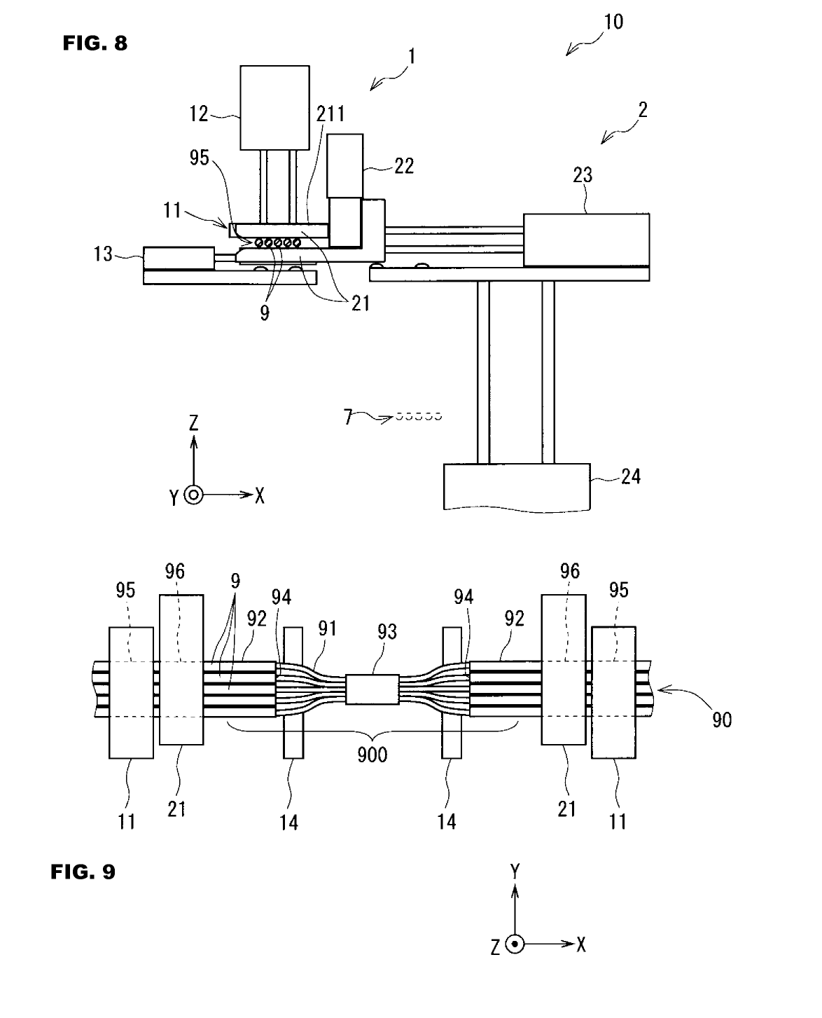

As shown in FIGS. 7 and 8, the second clamping step is a step of sandwiching, between the pair of second supporting surfaces 213 and 214 of the pair of second clamping portions 21, the second covering portion 96 of the wire group 90 that has been clamped by the pair of first clamping portions 11 through the swinging step.

In the present step, the step of moving the pair of second clamping portions 21 to the position of the second covering portion 96 is performed by the operation of the transverse actuator 23 and the elevation actuator 24. The step of sandwiching the second covering portion 96 by the pair of second clamping portions 21 is performed by the operation of the second clamping actuator 22.

<Clamp-Releasing Step (Parallelism Maintaining Step)>

The clamp-releasing step is a step of releasing the clamping of the first covering portion 95 by the first clamping portion 11 after the second clamping step. The present step is performed by the operation of the first clamping actuator 12.

<Moving Step (Parallelism Maintaining Step)>

The moving step is a step of moving the wire group 90 to the position 7 for the waterproof portion forming step by moving the pair of second clamping portions 21 clamping the wire group 90 after the clamp-releasing step. The present step is performed by the operation of the transverse actuator 23 and the elevation actuator 24.

<Waterproof Portion Forming Step>

After the wire group 90 has been moved to the position 7 for the waterproof portion forming step, the waterproof portion forming step is performed. The waterproof portion forming step is a step of covering, with the fluid waterproofing material 81, the waterproof region 900 of the wire group 90 whose parallel state is maintained by the parallelism maintaining step, and further curing the waterproofing material 81.

In the present embodiment, the waterproof portion forming step includes a sheet placement step, a waterproofing material supply step, a sheet enveloping step, and an exposure step. Here, two cases are possible, namely, a case where the waterproofing material supply step is performed before the sheet placement step, and a case where the waterproofing material supply step is performed after the sheet placement step. In the following description, the former case is referred to as a first example, and the latter case is referred to as a second example.

<First Example of Sheet Placement Step and Waterproofing Material Supply Step (Waterproof Portion Forming Step)>

As shown in FIG. 12, the waterproofing material supply step is performed first in the first example. In the first example of the waterproofing material supply step, the fluid waterproofing material 81 containing a photo-curable resin is supplied to a position on the transparent sheet member 82 where the waterproof region 900 is to be disposed.

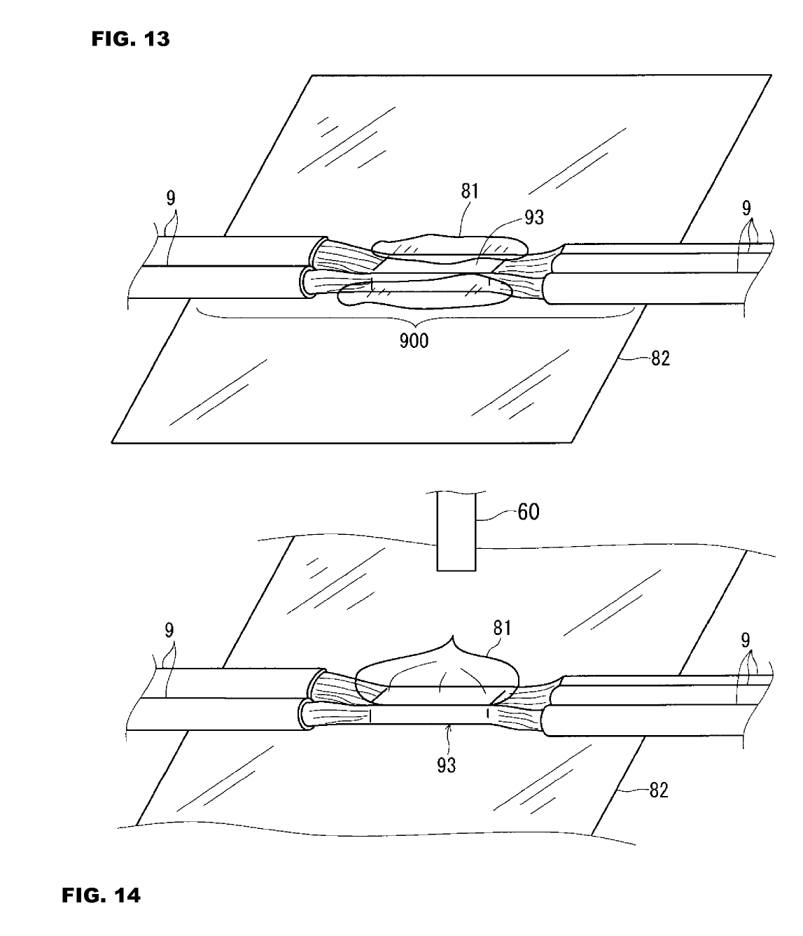

Subsequently, the sheet placement step is performed as shown in FIG. 13. The sheet placement step is a step of maintaining the waterproof region 900 of the wire group 90 whose parallel state is maintained by the parallelism maintaining step in a state in which the waterproof region 900 is laid on the transparent sheet member 82.

In the first example of the sheet placement step, the waterproof region 900 is laid on the sheet member 82 such that a part of the spliced portion 93 is immersed in the waterproofing material 81 on the sheet member 82 supplied by the waterproofing material supply step.

On the other hand, in the second example, the sheet placement step is performed first, and the waterproofing material supply step is performed subsequently. As shown in FIG. 14, in the second example of the waterproofing material supply step, the fluid waterproofing material 81 containing a photo-curable resin is supplied to the portion on the transparent sheet member 82 at which the waterproof region 900 is disposed, in particular, the portion at which the spliced portion 93 is disposed.

In the waterproofing material supply step, the waterproofing material 81 is in a fluid state having sufficient fluidity to spread between the wires 9 of the waterproof region 900 and sufficient viscosity to maintain the supplied state to a certain degree.

As the waterproofing material 81, it is possible to use various curing-type resins that can be cured after being applied in the fluid state having the above-described fluidity and viscosity. In the present embodiment, a photo-curable resin is used as the curable resin of the waterproofing material 81. A typical example of the photo-curable resin is an ultraviolet curable resin.

For example, an ultraviolet curable resin is a synthetic resin including a photoinitiator and mainly composed of an acrylate oligomer such as urethane acrylate, silicone acrylate and epoxy acrylate, and an acrylate monomer. From the viewpoint of curing the waterproofing material 81 in a short time to form the waterproof portion 8, it is preferable to use a photo-curable resin (usually, an ultraviolet curable resin). The present embodiment is an example in which an ultraviolet curable resin is used as the waterproofing material 81.

<Sheet Enveloping Step (Waterproof Portion Forming Step)>

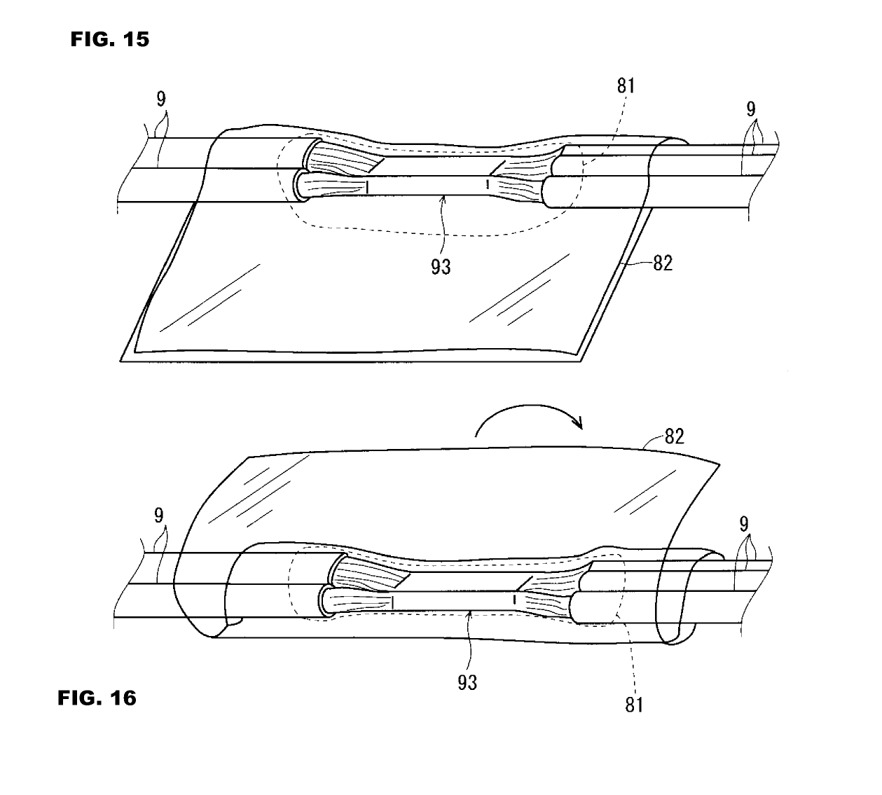

After the sheet placement step and the waterproofing material supply step, a sheet enveloping step is performed. As shown in FIGS. 15 and 16, the sheet enveloping step is a step of enveloping the waterproof region 900 of the wire group 90 by the sheet member 82 to which the waterproofing material 81 has been supplied. As a result of the waterproof region 900 being enveloped by the sheet member 82, the gap between the waterproof region 900 and the sheet member 82 is filled with the fluid waterproofing material 81.

In the example shown in FIGS. 15 and 16, the sheet member 82 is wrapped around the spliced portion 93 and the waterproofing material 81 after being folded into two. Consequently, the spliced portion 93 and the fluid waterproofing material 81 are enveloped by the sheet member 82.

However, the method for enveloping the spliced portion 93 and the waterproofing material 81 by the sheet member 82 is not limited thereto. Note that specific examples of the method and the device for enveloping the spliced portion 93 and the waterproofing material 81 by the sheet member 82 are described in Patent Document 2, for example.

As a result of the sheet enveloping step, the fluid waterproofing material 81 fills the gap between the waterproof region 900 and the sheet member 82, and covers the periphery of the waterproof region 900. Further, the waterproofing material 81 can easily spread into the gaps between the plurality of wires 9 due to the pressure received from the sheet member 82.

<Exposure Step (Waterproof Portion Forming Step)>

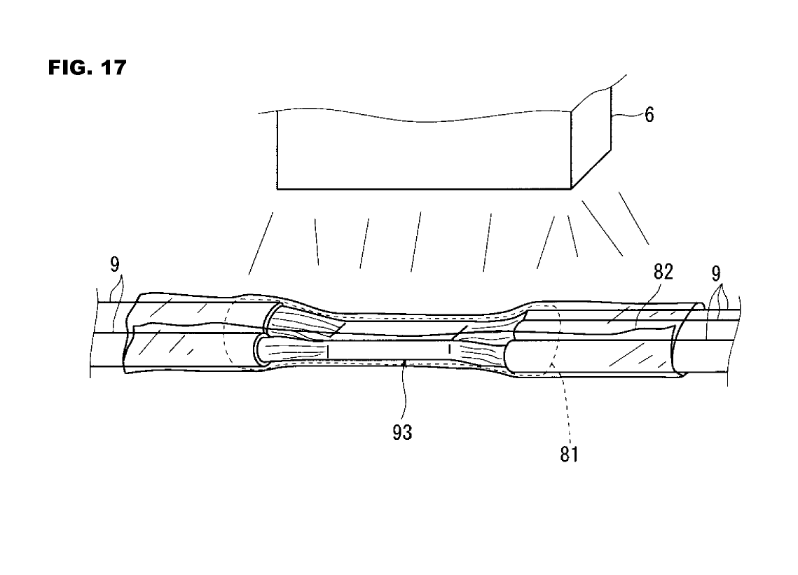

The exposure step is performed after the sheet enveloping step. As shown in FIG. 17, the exposure step is a step of applying light to the waterproofing material 81 covering the waterproof region of the wire group 90 from the outside of the sheet member 82. In the exposure step, the waterproofing material 81 wrapped with the sheet member 82 is exposed to the output light from an exposure device 6.

When the waterproofing material 81 contains an ultraviolet curable resin, ultraviolet radiation (ultraviolet light) is applied in the exposure step. Note that the exposure step is an example of the step of curing the fluid waterproofing material 81.

<Effects>

According to the embodiment described above, the first covering portion 95, which is located close to the waterproof region 900 of the wire group 90, is sandwiched between the pair of first clamping portions 11. Furthermore, the pair of first clamping portions 11 are reciprocally displaced relative to each other and parallel to the first supporting surfaces 113 and 114, while sandwiching the first covering portion 95.

As shown in FIGS. 4 to 6, when the pair of first clamping portions 11 are reciprocally displaced relative to each other, the wires 9 collapse from the stacked state. As a result, the first covering portion 95 is in the parallel state in which all the wires 9 are arranged in parallel along the first supporting surfaces 113 and 114.

In the parallel state in which all the wires 9 are arranged in parallel without being stacked, a dead zone into which the fluid waterproofing material 81 is difficult to flow cannot be easily created. In other words, the fluid waterproofing material 81 can easily spread into the gaps between all the wires 9. As a result, a sufficient waterproofing performance can be ensured when the waterproof portion 8 covering the spliced portion 93 of the wire group 90 is obtained by curing the fluid synthetic resin.

The wire group 90 is transferred from the pair of first clamping portions 11 clamping the first covering portion 95 to the pair of second clamping portions 21 clamping the second covering portion 96, which is located closer to the spliced portion 93 than the first covering portion 95. Further, the wire group 90 is moved to the position 7 for the waterproof portion forming step while being clamped by the pair of second clamping portions 21.

Accordingly, even when the waterproof portion forming step is performed at a position different from the position for the first clamping step, the portion of the wire group 90 that extends from the second covering portion 96 to the covering end portion 94 is maintained in the parallel state at the end of the swinging step.

Accordingly, the waterproof portion forming step for a wire group 90 and the steps (the first clamping step and the swinging step) of aligning another wire group 90 into the parallel state can be performed in parallel. As a result, a wire harness including the waterproof portion 8 that covers the spliced portion 93 can be manufactured efficiently.

The waterproofing material 81 in the present embodiment is a portion formed as a result of the fluid synthetic resin containing a photo-curable resin having been cured by receiving light from the outside of the transparent sheet member 82 enveloping the fluid synthetic resin. When a photo-curable resin is used as the waterproofing material 81, a dead zone where applied light is difficult to reach tends to be created at a portion where the wires 9 are stacked. Accordingly, it is particularly preferable to apply the present embodiment to such a subject.

The wire group alignment apparatus shown in FIG. 1 can perform the first clamping step, the swinging step, and the parallelism maintaining step in parallel at positions located on opposite sides of the spliced portion 93 formed at an intermediate portion of the wire group 90.

<Others>

In the embodiment described above, each of the pair of first supporting surfaces 113 and 114 is a flat surface. However, each of the pair of first supporting surfaces 113 and 114 may be an arc surface with a relatively small curvature. In this case, the swing mechanism 13 reciprocally displaces the first receiving portion 112 along the arc surfaces.

As the curable resin for the waterproofing material 81, it is possible to use, for example, a thermosetting resin such as an epoxy resin or an acrylic resin. Apart from these, a moisture curable resin typified by a moisture curable silicone may be used as the curable resin.

When the subject to be processed is a wire group having the spliced portion 93 formed at its end portion, one of the two sets of alignment mechanisms 1 and one of the two sets of parallelism maintaining mechanisms 2 of the wire group alignment apparatus 10 may be omitted.

The parallelism maintaining mechanism 2 of the wire group alignment apparatus 10 may be implemented by a mechanism other than the mechanism shown in FIG. 1, including, for example, an arm mechanism of a so-called industrial robot.

Note that the waterproofing method of a wire spliced portion and the wire group alignment apparatus according to the present invention can be configured by freely combining the above-described embodiments and exemplary applications, or by modifying or partly omitting the embodiments and exemplary applications, as needed, within the scope of the invention as set forth in the claims.

### REFERENCE SIGNS LIST

1 Alignment mechanism
2 Parallelism maintaining mechanism
6 Exposure device
7 Position for waterproof portion forming step
8 Waterproof portion
9 Wire (Insulated wire)
10 Wire group alignment apparatus
11 Pair of first clamping portions
12 First clamping actuator
13 Swing mechanism
14 Wire supporting portion
21 Second clamping portion
22 Second clamping actuator (Movement mechanism)
23 Transverse actuator (Movement mechanism)
24 Elevation actuator
81 Waterproofing material
82 Sheet member
83 Spliced portion
90 Wire group
91 Conductor
92 Insulating covering
93 Spliced portion
94 Covering end portion
95 First covering portion
96 Second covering portion
111 First pressing portion
112 First receiving portion
113, 114 First supporting surface
211 Second pressing portion
212 Second receiving portion
213, 214 Second supporting surface
900 Waterproof region

1. A waterproofing method of a wire spliced portion, comprising:
first clamping including sandwiching, between a parallel pair of first supporting surfaces of a mutually opposed pair of first clamping portions, a first covering portion of a wire group including a plurality of insulated wires and having a spliced portion where conductors of the insulated wires are joined, the first covering portion being located at a position spaced from an end portion of an insulating covering that faces the spliced portion;
swinging including reciprocally displacing one of the pair of first clamping portions sandwiching the first covering portion relative to the other and parallel to the first supporting surfaces;
parallelism maintaining including maintaining at least the end portion of the insulating covering of the wire group in a parallel condition at the end of the swinging; and
waterproof portion forming including covering, with a fluid waterproofing material, a waterproof region of the wire group whose parallel condition is maintained by the parallelism maintaining, and further curing the waterproofing material, the waterproof region extending from the spliced portion to the end portion of the insulating covering.

2. The waterproofing method of a wire spliced portion according to claim 1,
wherein the parallelism maintaining includes:
second clamping including sandwiching, between a pair of second supporting surfaces, parallel to the first supporting surfaces, of a mutually opposed pair of second clamping portions, a second covering portion of the wire group clamped by the pair of first clamping portions through the swinging, the second portion being located between the first covering portion and the end portion of the insulating covering;
clamp-releasing including releasing the clamping by the first clamping portions after the second clamping; and
moving including moving the wire group to a position for the waterproof portion forming by moving the pair of second clamping portions clamping the wire group after the clamp-releasing.

3. The waterproofing method of a wire spliced portion according to claim 1,
wherein the waterproof portion forming includes:
sheet placement including maintaining the waterproof region of the wire group whose parallel condition is maintained by the parallelism maintaining in a condition in which the waterproof region is laid on a transparent sheet member;
waterproofing material supply including supplying the fluid waterproofing material onto the sheet member, the waterproofing material containing a photo-curable resin;
sheet enveloping including filling a gap between the waterproof region of the wire group and the sheet member with the fluid waterproofing material by enveloping the waterproof region of the wire group with the sheet member to which the waterproofing material has been supplied; and
exposure including applying light, from outside of the sheet member, to the waterproofing material covering the waterproof region of the wire group.

4. The waterproofing method of a wire spliced portion according to claim 1,
wherein the first clamping, the swinging, and the parallelism maintaining are performed in parallel at positions located on opposite sides of the spliced portion, the spliced portion being formed at an intermediate portion of the wire group.

5. A wire group alignment apparatus that aligns a portion of an insulating covering of a wire group including a plurality of insulated wires and having a spliced portion where conductors of the insulated wires are joined, into a condition in which the plurality of the insulated wires are arranged in a line, comprising:
a pair of first clamping portions that have a parallel pair of first supporting surfaces and that sandwich, between the pair of first supporting surfaces, a first covering portion of the wire group that is located at a position spaced from an end portion of the insulating covering that faces the spliced portion; and
a swing mechanism that reciprocally displaces one of the pair of first clamping portions sandwiching the first covering portion relative to the other and parallel to the first supporting surfaces.

6. The wire group alignment apparatus according to claim 5, further comprising:
a pair of second clamping portions that have a pair of second supporting surfaces parallel to the first supporting surfaces, and that sandwich, between the pair of second supporting surfaces, a second covering portion located between the first covering portion and the end portion of the insulating covering of the wire group clamped by the pair of first clamping portions; and
a movement mechanism that moves the pair of second clamping portions clamping the wire group after the clamping by the first clamping portions is released.
